(19) United States
(12) Patent Application Publication
(10) Pub. No.: US 2006/0252856 A1
(43) Pub. Date: Nov. 9, 2006

(54) Additives for extending pot life of 2-component polyurethane coatings

(75) Inventors: Janis Wylam Anderson, Danbury, CT (US); Michael Haraczy, Trafford, PA (US)

Correspondence Address: Norris, McLaughlin & Marcus P.A., 18th Floor, 875 Third Avenue, New York, NY, 10022, US

(73) Assignee: R. T. Vanderbilt Company, Inc., Nowalk, CT (US)

(21) Appl. No.: 11/393,243

(22) Filed: Mar. 30, 2006

Related U.S. Application Data
(60) Provisional application No. 60/677,692, filed on May 4, 2005.

(51) Int. Cl. C08K 5/34

(52) U.S. Cl. 524/92; 524/431

(57) ABSTRACT

The invention relates to an additive system for increasing the pot life of two-component, solvent-borne polyurethane coatings; such polyurethane coatings in combination with the additive; as well as a method for increasing pot life based on using the additive in combination with such coatings. The additive is based on cobalt at from 0.01-0.10% and an organic chelating agent at 0.03-0.5%, all percentages expressed as mass percent of resin solids. Preferred amounts of cobalt are about 0.02-0.04% and preferred amounts of chelating agent are about 0.066-0.15%. As it is more preferred to use the least amount of additive, a more preferred additive composition contains about 0.02% cobalt and about 0.06-0.08% chelating agent. It is also possible to express the components in terms of a ratio, wherein a preferred composition is between about 1:5 to about 1:20 cobalt:chelating agent, with a most preferred composition at about 1:3.8

### BACKGROUND OF THE INVENTION

1. Field of the Invention

The invention relates to the field of 2-component (2K), solvent-borne polyurethane coatings. Such coatings require a metal catalyst to accelerate the cure rate. The most frequently used catalyst metal is tin, usually in the form of dibutyltin dilaurate (DBTDL) and/or zinc. A chelating agent such as 2,4-pentanedione, is commonly used in conjunction with tin for polyurethane coatings for pot life extension and viscosity stability. When preparing this type of polyurethane coating, one must balance the properties of cure rate and pot life, so as to give sufficient working time without unduly extending the cure time. While tin is excellent for cure rate, it yields short pot life. Therefore, there is a desire to prepare an additive combination which will increase the pot life of 2-component, solvent-borne polyurethane coatings, without increasing the cure time beyond an acceptable level.

2. Discussion of the Prior Art

2-component (2K), solvent-borne polyurethane coatings are well known in the prior art since at least the 1930s. The chemical reaction that results in the production of polyurethanes is described in German Patent 728,981 (1937), German Patent 913,474 (1941) and German Patent 851,851 (1948). 2K urethane coatings are based on reactions of polyols and isocyanates. The chemical reaction is as follows:
R—NCO+R′—OH→RHNCOOR′

The presence of certain metals, most often tin and/or zinc, has been found to increase the rate of reaction. The catalyzed reaction proceeds at a very fast rate. This is good for the drying of the coating, but not for application of the coating. The reaction can be so rapid that the coating is fully reacted before it is even applied to the substrate. The viscosity of the coating increases as the reaction proceeds to a gel. Pot life or bench life is the term used to define how long the coating is useful before the viscosity reaches a level at which the user can no longer apply the coating.

In order to increase pot life, it has been the practice to include 2,4-pentanedione, in combination with tin or zinc, or other metals such as zirconium, manganese, vanadium and aluminum. Florio, J. J. and Miller, D. J., Handbook of Coatings Additives, 2nd Ed. However, though pot life is extended, it is still below the commercially acceptable life of 6 hours or more.

U.S. Pat. No. 5,447,968 teaches a polyurethane-forming foundry binder system containing a nitrogen-containing aromatic compound, such as 2,2-dipyridil and 1,10-phenathroline, for extending bench life (also known as pot life). The aromatic compounds are used in combination with zinc as a metal catalyst. However, it was found by the inventors that zinc or tin, in combination with either of these compounds, did not increase the pot life for a 2K polyurethane floor coating.

1,10 phenanthroline (for example as ACTIV-8® drier accelerator available from R.T. Vanderbilt Company, Inc., as 38% solution of 1,10 phenanthroline in n-butanol or hexylene glycol) is a known drier accelerator used for a different type of coating, i.e. alkyd coatings, usually with cobalt or manganese as the metal catalyst. Alkyd coatings dry by way of an oxidative process, in which oxygen from the air cross-links the resin. In contrast, drying of polyurethane coatings is by way of crosslinking of isocyanate with a polyol. Because of the starkly different drying mechanism, there was no motivation to use 1,10 phenathroline for polyurethane coatings. Furthermore, it was believed that as 1,10 phenathroline is non-volatile, it would remain in a polyurethane coating and adversely affect the cure rate.

### SUMMARY OF THE INVENTION

Therefore, it was quite surprising that when 1,10 phenanthroline is used with a 2K polyurethane coating, with a cobalt catalyst replacing tin, a striking improvement in pot life was achieved. In fact, the pot life was increased from 4 hours up to 24 hours in some cases. This is surprising not only because 1,10 phenathroline has not heretofore been known to be effective in coatings other than alkyds as a drier accelerator, but more importantly, the issue of pot life extension is simply not an issue with respect to alkyd coatings.

In view of the above, it is also expected that other organic chelating agents which are effective as drier accelerators for alkyd systems, will work as pot life extenders for 2K polyurethane coatings when combined with cobalt as a metal catalyst. Such agents include nitrogen-containing aromatic compounds, such as 2,2-dipyridil and 1,10-phenathroline, and their substituted alkyl derivatives. In particular, it was found that 2,2-dipyridil (for example as Dri-Rx® drier accelerator from OMG Americas, a 30% solution of 2,2-dipyridyl) was also effective in increasing pot life while providing acceptable cure rate. Other organic chelating agents which should work in the present invention, based on similar activity for paint drying as the exemplified compounds, include diamine type chelating agents as forth in U.S. Pat. No. 2,961,331, which is incorporated herein by reference, including 2-(2-pyridyl)-benzimidazole, 1-(2-pyridylazo)-2-naphthol, 2-picolylamine, 2,2′dipyridylamine, 2-pyridinemethaldoxime, 2-pyridinealdoxime, 2-(2-pryidyl)-benzoxazole, 2-pyridinaldazine, bis-(2-pyridinal)-ethylenediamine.

As set out above, it was surprising to find that organic chelating agents such as 1,10 phenathroline and 2,2-dipyridyl when used with cobalt are effective in increasing pot life for 2K polyurethane coatings. However, it was additionally surprising to find that cobalt, replacing tin in the standard 2K polyurethane formula including 2,4-pentanedione, also provides improved superior pot life. Therefore, it seems that cobalt in combination with an organic chelating agent is the key to extending pot life for 2K polyurethane coatings.

The invention, therefore, relates to an additive system for increasing the pot life of two-component, solvent-borne polyurethane coatings; such polyurethane coatings in combination with the additive; as well as a method for increasing pot life based on using the additive in combination with such coatings. The additive is based on cobalt at 0.01-0.10% and an organic chelating agent at from about 0.03-0.5%, all percentages throughout the specification expressed as mass percent of the resin solids. Preferred amounts of cobalt are about 0.02-0.04%; and preferred amounts of chelating agent are about 0.05-0.16%. As it is more preferred to use the least amount of additive, a more preferred additive composition contains about 0.02% cobalt and about 0.06-0.08% chelating agent. It is also possible to express the components in terms of a ratio, wherein a preferred composition is between about 1:1 to about 1:20 cobalt:chelating agent, with a most preferred composition at about 1:3.8 where chelating agent is 1,10 phenanthroline, and 1:3.0 for 2,2-dipyridil; all on a dry basis.

### DETAILED DISCUSSION OF THE INVENTION

The following data demonstrate that cobalt plus a chelating agent in a 2K polyurethane coating, yields extended pot life, slower cure rate and better film hardness than control formulas based on tin and zinc.

The 2K polyurethane floor coating was prepared according to Table 1. The two components A and B were blended and mixed at a slow speed for 10 minutes. The Brookfield 50 rpm viscosity was measured at 30 minute intervals until the viscosity was >20,000 cps. Drawdowns were made at 8 mil clearance onto plain white cards at 30 minute intervals, for the length of the pot life. The coatings were cured at 75° F., 50% RH. The Sward Rocker hardness was measured after 24, 48, 96 and 240 hours according to ASTM D 2134. One hour after the two components were blended, drawdowns were made 8 mil clearance onto glass panels, for Gardiner Circular Dry Time Recorder tests.

TABLE 1
Part A

| | | |
|---|---|---|
| Desmophen ® 650 A 65 PMA | 30.9% | (Bayer AG) |
| Desmophen R 221 | 03.0 | (Bayer AG) |
| Byk ® P 104 | 00.6 | (Byk-Chemie America) |
| Lactimon ® | 00.6 | (Byk-Chemie America) |
| Arcosolv ® PM Acetate | 08.9 | (Lyondell Chemical) |
| Ti-Pure ® R 900 | 23.7 | (E.I. duPont de |
| | | Neumours) |
| Raven ® Black 1255 | 00.6 | (Columbian Chemicals) |
| Byk 354 | 00.7 | (Byk-Chemie America) |
| Metal catalyst | per Table 2 | |
| Chelating Agent | per Table 2 | |

Part B

| | | |
|---|---|---|
| Desdomur ® N 75 BA/X | 28.2 | (Bayer AG) |

(amounts are approximate; totals may not equal 100% due to rounding; metal catalysts and chelating agent are added as part of a blend, with total weight of blend counted towards total weight of coating in Table 1. In Table 2, percentage of metal or chelating agent alone is shown based on resin solids)

TABLE 2

| Formula | Sn | Zn | Co | Chelating Agent |
|---|---|---|---|---|
| | | | | 1,10-phenanthroline (1) |
| A | 0.02 | 0.003 | — | — |
| B | 0.02 | 0.003 | — | 0.076 |
| C | 0.02 | — | — | 0.076 |
| D | — | — | 0.02 | 0.076 |
| E | — | — | 0.04 | 0.152 |
| F | 0.02 | — | 0.02 | 0.076 |
| | | | | 2,2-dipyridil (2) |
| G | 0.02 | 0.003 | — | 0.06 |
| H | 0.02 | — | — | 0.06 |
| I | — | — | 0.02 | 0.06 |
| J | — | — | 0.04 | 0.12 |
| K | 0.02 | — | 0.02 | 0.06 |
| | | | | 2,4-pentanedione |
| L | 0.02 | 0.003 | — | 0.2 |
| M | 0.02 | — | — | 0.2 |
| N | — | — | 0.02 | 0.2 |
| O | — | — | 0.04 | 0.4 |
| P | 0.02 | — | 0.02 | 0.2 |

(1) Provided as ACTIV-8 ® containing 38% 1,10-phenanthroline
(2) Provided as Dri-RX ® containing 30% 2,2-dipyridil.

The results of the testing are set forth in Table 3 below. A pot life of 6 hours or below is considered to be unacceptable. Pot life given as >7½ is considered acceptable for commercial purposes. The actual pot life for >7½ is between 7½ and 24 hours.

TABLE 3

| | | |
|---|---|---|
| Pot Life | Through Dry | Sward Hardness |

| Formula | (hours) | (hours) | 24 hours | 240 hours |
|---|---|---|---|---|
| A | 4 | 3 | 14 | 26 |
| B | 5½ | 3½ | 16 | 27 |
| C | 5½ | 4½ | 15 | 27 |
| D | 24 | 11 | 12 | 29 |
| E | >7½ | 8½ | 13 | 27 |
| F | 2½ | 3 | 13 | 27 |
| G | 4 | 3¼ | 14 | 26 |
| H | 4 | 3 | 13 | 25 |
| I | >7½ | 11 | 11 | 27 |
| J | 6 | 8½ | 11 | 24 |
| K | 2½ | 3 | 13 | 25 |
| L | 4 | 3 | 13 | 25 |
| M | 5 | 3¼ | 12 | 26 |
| N | >7½ | 10½ | 11 | 28 |
| O | 3 | 6½ | 13 | 27 |
| P | 2½ | 3 | 14 | 26 |

In conclusion, the longest pot life is consistently achieved with cobalt plus a chelating agent. All of the tested chelating agents provided improved pot life and good cure rate when combined with cobalt, as compared to tin and/or zinc, and are therefore considered as part of the invention. However, a preferred composition includes 1,10 phenanthroline (ACTIV-8® drier accelator), as it provided superior film hardness.

What is claimed is:

1. A coating composition, comprising:
a 2-component, solvent-borne polyurethane composition,
cobalt, and
an organic chelating agent.

2. The composition of claim 1, wherein the chelating agent is chosen as 1,10 phenanthroline or 2,2-dipyridil.

3. The composition of claim 2, wherein the chelating agent comprises 1,10 phenanthroline.

4. The composition of claim 1, wherein cobalt is present at about 0.01-0.10% and the organic chelating agent is present at about 0.03-0.5%, based on mass percent of resin solids.

5. The composition of claim 4, wherein cobalt is present at about 0.02-0.04% and the organic chelating agent is present at about 0.05-0.16%.

6. The composition of claim 5, wherein cobalt is present at about 0.02% and the organic chelating agent is present at about 0.06-0.08%.

7. The composition of claim 1, wherein the ratio of cobalt to organic chelating agent is about 1:1 to 1:20.

8. The composition of claim 7, wherein the ratio is about 1:3.8 where the chelating agent is 1,10 phenanthroline and about 1:3.0 where the chelating agent is 2,2-dipyridil.

9. The composition of claim 1, wherein cobalt is present at about 0.02-0.04% and the organic chelating agent is 1,10 phenanthroline and is present at about 0.03-0.5%, based on mass percent of resin solids.

10. A method of increasing the pot life in a 2-component, solvent-borne polyurethane composition, comprising the step of adding to said polyurethane composition an additive composition comprising cobalt and an organic chelating agent.

11. The method of claim 10, wherein the chelating agent is chosen as 1,10 phenanthroline or 2,2-dipyridil.

12. The method of claim 11, wherein the chelating agent comprises 1,10 phenanthroline.

13. The method of claim 10, wherein the additive composition is formulated to provide cobalt at about 0.01-0.10% and the organic chelating agent at about 0.03-0.5%, as mass percent of resin solids of the polyurethane composition and additive composition.

14. The method of claim 13, wherein the additive composition is formulated to provide cobalt at about 0.02-0.04% and the organic chelating agent at about 0.05-0.16%.

15. The method of claim 14, wherein the additive composition is formulated to provide cobalt at about 0.02% and the organic chelating agent at about 0.06-0.08%.

16. The method of claim 10, wherein the ratio of cobalt to organic chelating agent is about 1:1 to 1:20.

17. The method of claim 16, wherein the ratio is about 1:3.8 where the chelating agent is 1,10 phenanthroline and about 1:3.0 where the chelating agent is 2,2-dipyridil.

18. The method of claim 10, wherein the organic chelating agent is 1,10 phenanthroline, and wherein the additive composition is formulated to provide cobalt at about 0.02-0.04% and the organic chelating agent at about 0.05-0.16%.
